(19) United States
(12) Patent Application Publication
(10) Pub. No.: US 2012/0284117 A1
(43) Pub. Date: Nov. 8, 2012

(54) METHOD AND SYSTEM FOR ADVERTISING

(76) Inventor: Jyothi Marie Karandikar, Turramurra (AU)

(21) Appl. No.: 13/515,790

(22) PCT Filed: Dec. 14, 2010
(86) PCT No.: PCT/AU2010/001687

§ 371 Date: Jun. 13, 2012

(30) Foreign Application Priority Data
Dec. 14, 2009 (AU) 2009906076

(51) Int. Cl. G06Q 30/02

(52) U.S. Cl. 705/14.49; 705/14.69

(57) ABSTRACT

A method, system, computer program product, server processing system and advertising processing system for providing an advertising service. In one aspect the method includes including, in a server processing system, steps of: publishing an advertisement, the advertisement being generated based upon advertising information received, by the server processing system, from an advertiser; forwarding, to the advertiser, a plurality of responses from a respective plurality of responders; receiving from the advertiser, shortlist data indicative of a portion of the responders which the advertiser shortlisted; and awarding the responders who have been shortlisted. In other aspects, there is provided a method, server processing system, system and computer readable medium for enabling a searching party to conduct a search and shortlist advertising parties returned in search results, wherein the shortlisted advertising parties are rewarded accordingly.

### CROSS REFERENCE TO RELATED APPLICATIONS

This application is a continuation-in-part application of the national phase entry of PCT/AU2010/001687 which is hereby incorporated by reference.

### FIELD OF THE INVENTION

The present invention relates to a method, system, server processing system, client processing system, and/or computer program product for advertising.

### DESCRIPTION OF THE BACKGROUND ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Presently, an advertiser for a product can search for potential suppliers. Once some likely suppliers have been identified, the advertiser may then proceed to choose the most suitable supplier. Thus, all other suppliers which may have been previously considered are then typically discarded, without receiving any recognition for being considered as a possible supplier. It will be appreciated that this problem can also exist for an advertiser who is a supplier of a product, wherein the supplier may need to choose between a number of potential purchasers. It will also be appreciated that this problem exists for tangible products, such as goods, and intangible products, such as services.

Thus, there is required a system, method and/or computer program product for advertising, which overcomes, at least ameliorates one or more disadvantages of existing arrangements, or provides an alternative to existing arrangements.

### SUMMARY OF THE PRESENT INVENTION

In one broad aspect there is provided a method of providing an advertising service including, in a server processing system, steps of:
publishing an advertisement, the advertisement being generated based upon advertising information received, by the server processing system, from an advertiser;
forwarding, to the advertiser, a plurality of responses from a respective plurality of responders;
receiving from the advertiser, shortlist data indicative of a portion of the responders which the advertiser shortlisted; and
awarding the responders who have been shortlisted.

In one form, the step of awarding each responder shortlisted includes the server processing system recording, in a data store associated with the server processing system, a credit in an account associated with each respective responder.

In another form, the method includes the server processing system selectively enabling communication between the advertiser and at least one responder shortlisted via the server processing system.

In one embodiment, the method includes the server processing system:
determining, using records stored in the data store, if one or more responders have purchased a subscription to use the advertising service; and
enabling the advertiser to freely communicate, via the server processing system, with each responder shortlisted who purchased a subscription.

In another embodiment, the method includes the server processing system:
determining, using records stores in the data store, if one of the responders has credit stored in a respective account to allow the advertiser to freely communicate with the respective responder; and
in the event of a positive determination, debiting the account, associated with the respective responder when shortlisted, to enable communication between the advertiser and the respective responder via the server processing system.

In an optional form, the method includes the server processing system:
identifying, using records stored in the data store, one or more of the responders who are restricted responders, each restricted responder failing to have purchased a subscription to use the advertising service and failing to have credit in an account for enabling free communication between the advertiser and the respective responder;
determining, using records stored in the data store, if the advertiser has met or exceeded a maximum threshold of restricted responders which the advertiser is able to freely communicate therewith during a predefined period;
in the event of a negative determination, updating the records stored in the data store indicative of the number of restricted responders which the advertiser has communicated therewith in the predefined period prior to enabling the advertiser to freely communicate with the restricted responder; and
in the event of a positive determination, debiting an account associated with the advertiser to enable the advertiser to freely communicate with at least one of the restricted responders.

In another optional form, the method includes, after the predefined period has expired, resetting the number of restricted responders the advertiser is able to freely communicate therewith for another predefined period of time.

In an optional embodiment, the method includes, in the server processing system:
determining, using records stored in the data store, if the advertiser has purchased a subscription for using the respective advertisement; and
in the event of a positive determination, enabling the advertiser to communicate freely with any of the responders which the advertiser shortlists.

In another optional embodiment:
the advertiser requests supply of a product and the plurality of responders are each interested suppliers of the product; or
the advertiser advertises supply of a product and the plurality of responders are each interested purchasers of the product.

Optionally, the product includes at least one of:
a good; and
a service.

In another broad aspect there is provided a server processing system for providing an advertising service, wherein the server processing system is configured to:
publish an advertisement, the advertisement being generated based upon advertising information received, by the server processing system, from an advertiser;
forward, to the advertiser, a plurality of responses from a respective plurality of responders;
receive from the advertiser, shortlist data indicative of a portion of the responders which the advertiser shortlisted; and
award the responders who have been shortlisted.

In one form, the server processing system is configured to award each responder shortlisted by recording, in a data store associated with the server processing system, a credit in an account associated with each respective responder.

In another form, the server processing system is configured to selectively enable communication between the advertiser and at least one responder shortlisted via the server processing system.

In one embodiment, the server processing system is configured to:
determine, using records stored in the data store, if one or more responders have purchased a subscription to use the advertising service; and
enable the advertiser to freely communicate, via the server processing system, with each responder shortlisted who purchased a subscription.

In another embodiment, the server processing system is configured to:
determine, using records stores in the data store, if one of the responders has credit stored in a respective account to allow the advertiser to freely communicate with the respective responder; and
in the event of a positive determination, debit the account, associated with the respective responder when shortlisted, to enable communication between the advertiser and the respective responder via the server processing system.

In an optional form, the server processing system is configured to:
identify, using records stored in the data store, one or more of the responders who are restricted responders, each restricted responder failing to have purchased a subscription to use the advertising service and failing to have credit in an account for enabling free communication between the advertiser and the respective responder;
determine, using records stored in the data store, if the advertiser has met or exceeded a maximum threshold of restricted responders which the advertiser is able to freely communicate therewith during a predefined period;
in the event of a negative determination, update the records stored in the data store indicative of the number of restricted responders which the advertiser has communicated therewith in the predefined period prior to enabling the advertiser to freely communicate with the restricted responder; and
in the event of a positive determination, debit an account associated with the advertiser to enable the advertiser to freely communicate with at least one of the restricted responders.

In another optional form, the server processing system is configured to reset the number of restricted responders the advertiser is able to freely communicate therewith after the predefined period has expired.

In an optional embodiment, the server processing system is configured to:
determine, using records stored in the data store, if the advertiser has purchased a subscription for using the respective advertisement; and
in the event of a positive determination, enable the advertiser to communicate freely with any of the responders which the advertiser shortlists.

In another optional embodiment:
the advertiser requests supply of a product and the plurality of responders are each interested suppliers of the product; or
the advertiser advertises supply of a product and the plurality of responders are each interested purchasers of the product.

Optionally, the product includes at least one of:
a good; and
a service.

In another broad aspect there is provided a method of providing an advertising service including, in an advertiser processing system operated by an advertiser in data communication with a server processing system, steps of:
transferring advertising information to the server processing system for publication;
receiving, from the server processing system, a plurality of responses from a respective plurality of responders; and
transferring, to the server processing system, shortlist data indicative of a portion of the responders which the advertiser shortlisted, wherein the responders who have been shortlisted are awarded.

In one form, the method includes enabling, at the advertiser processing system, the advertiser to communicate freely, via the server processing system, with one or more shortlisted responders which purchased a subscription to use the advertising service.

In another form, the method includes enabling, at the advertiser processing system, the advertiser to communicate freely, via the server processing system, with one or more shortlisted responders which have credit stored in a respective account to allow the advertiser to freely communicate with the respective responder, wherein the account of the one or more respective responders is debited accordingly.

In one embodiment:
the advertiser requests supply of a product and the plurality of responders are each interested suppliers of the product; or
the advertiser advertises supply of a product and the plurality of responders are each interested purchasers of the product.

In another embodiment, the product includes at least one of:
a good; and
a service.

In another broad aspect there is provided an advertiser processing system for providing an advertising service, the advertiser processing system operated by an advertiser in data communication with a server processing system, wherein the advertiser processing system is configured to:
transfer advertising information to the server processing system for publication;
receive, from the server processing system, a plurality of responses from a respective plurality of responders; and
transfer, to the server processing system, shortlist data indicative of a portion of the responders which the advertiser shortlisted, wherein the responders who have been shortlisted are awarded.

In one form, the advertiser processing system is configured to enable the advertiser to communicate freely, via the server processing system, with one or more shortlisted responders which purchased a subscription to use the advertising service.

In another form, the advertiser processing system is configured to enable the advertiser to communicate freely, via the server processing system, with one or more shortlisted responders which have credit stored in a respective account to allow the advertiser to freely communicate with the respective responder, wherein the account of the one or more respective responders is debited accordingly.

In one embodiment:
the advertiser requests supply of a product and the plurality of responders are each interested suppliers of the product; or
the advertiser advertises supply of a product and the plurality of responders are each interested purchasers of the product.

In another embodiment, the product includes at least one of:
a good; and
a service.

In another broad aspect there is provided a system for providing an advertising service, wherein the system includes a server processing system in data communication with an advertiser processing system operated by an advertiser and a plurality of responder processing systems operated by a respective plurality of suppliers, wherein the system is configured to
transfer, from the advertiser processing system to the server processing system, advertising information for publishing an advertisement to the plurality of responder processing systems;
receive, at the server processing system from at least some of the supplier processing systems, a plurality of responses;
forward, from the server processing system to the advertiser processing system, the plurality of responses;
transfer, from the advertiser processing system to the server processing system, shortlist data indicative of a shortlist of the suppliers who responded; and
award, at the server processing system, the responders who have been shortlisted.

In another broad aspect there is provided a method of providing an advertising service, wherein the advertising service utilises a server processing system in data communication with an advertiser processing system operated by an advertiser and a plurality of responder processing systems operated by a respective plurality of suppliers, wherein the method includes:
transferring, from the advertiser processing system to the server processing system, advertising information for publishing an advertisement to the plurality of responder processing systems;
receiving, at the server processing system from at least some of the supplier processing systems, a plurality of responses;
forwarding, from the server processing system to the advertiser processing system, the plurality of responses;
transferring, from the advertiser processing system to the server processing system, shortlist data indicative of a shortlist of the suppliers who responded; and
awarding, at the server processing system, the responders who have been shortlisted.

In another aspect there is provided a server processing system configured to:
receive a plurality of advertisements from a plurality of advertising parties;
receive, from a searching party, search criteria;
generate search results by searching the plurality of advertisements according to the search criteria, wherein the search results include one or more advertisements by one or more advertising parties;
forward, to the searching party, the search results;
receive from the searching party, shortlist data indicative of a portion of the advertisers which the searching party shortlisted; and
award the portion of the advertisers who have been shortlisted.

In one embodiment, the server processing system is configured to selectively enable communication between the searching party and one or more advertising parties shortlisted via the server processing system.

In another embodiment, the server processing system is further configured to:
determine, using records stored in the data store, if one or more of the advertising parties has credit stored in a respective account to allow the searching party to freely communicate with the respective one or more advertising parties; and
in the event of a positive determination, debit the account, associated with the respective one or more advertising parties when shortlisted, to enable communication between the searching party and the respective one or more advertising parties via the server processing system.

In another embodiment, the server processing system is configured to:
determine, using records stored in the data store, if one or more advertising parties have purchased a subscription to use the advertising service; and
enable the searching party to freely communicate, via the server processing system, with each advertising party shortlisted who purchased a subscription.

In another embodiment, the server processing system is configured to:
identify, using records stored in the data store, one or more of the advertising parties who are restricted advertising parties, each restricted advertising party failing to have purchased a subscription to use the advertising service and failing to have credit in an account for enabling free communication between the searching party and the respective advertising party;
determine, using records stored in the data store, if the searching party has met or exceeded a maximum threshold of restricted advertising parties which the searching party is able to freely communicate therewith during a predefined period;
in the event of a negative determination, update the records stored in the data store indicative of the number of restricted advertising parties which the searching party has communicated therewith in the predefined period prior to enabling the searching party to freely communicate with the restricted advertising party; and
in the event of a positive determination, debit an account associated with the searching party to enable the searching party to freely communicate with at least one of the restricted advertising parties.

In another embodiment, the searching party searches for supply of a product or service by an advertising party; or the searching party searches for advertising parties to supply a product or service thereto.

In another aspect there is provided a computer readable medium including executable instructions for configuring a server processing system to:
receive a plurality of advertisements from a plurality of advertising parties;
receive, from a searching party, search criteria;
generate search results by searching the plurality of advertisements according to the search criteria, wherein the search results include one or more advertisements by one or more advertising parties;
forward, to the searching party, the search results;
receive from the searching party, shortlist data indicative of a portion of the advertisers which the searching party shortlisted; and
award the portion of the advertisers who have been shortlisted.

Other embodiments will be appreciated throughout the description provided herein.

### BRIEF DESCRIPTION OF THE DRAWINGS

An example of the present invention will now be described with reference to the accompanying drawings, in which:—

FIG. 1A is a flowchart representing an example method for providing an advertising service;

FIG. 1B is another flowchart representing a more specific example method for providing the advertising service;

FIG. 2 is an example network infrastructure that can be utilised to embody or give effect to a particular embodiment;

FIG. 3 is a functional block diagram of an example processing system suitable for use as a server processing system;

FIG. 4 is a functional block diagram of an example processing system suitable for use as an advertiser or responder processing system;

FIG. 5 is another flowchart representing an example method for providing the advertising service;

FIG. 6 is another flowchart representing a more specific example method for providing the advertising service;

FIG. 7 is a block diagram representing a system for providing an advertising service;

FIG. 8 is a flow chart representing an example method of a searching party conducting a search for an advertisement;

FIG. 9 is a flow chart represent another example method of a searching party establishing communication with one or more shortlisted advertising parties; and

FIG. 10 is a functional block diagram representing an example system for enabling a searching party to conduct a search for an advertisement.

### DETAILED DESCRIPTION INCLUDING BEST MODE

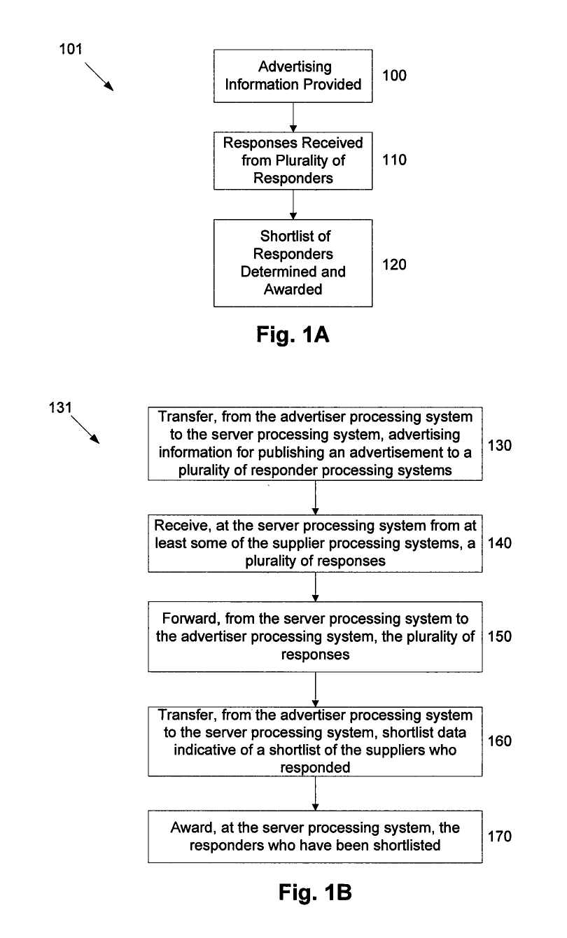

An example of a method will now be described with reference to FIG. 1A. The method 101 of FIG. 1A can be performed by a processing system which is preferably a distributed processing system as will be discussed in more detail below.

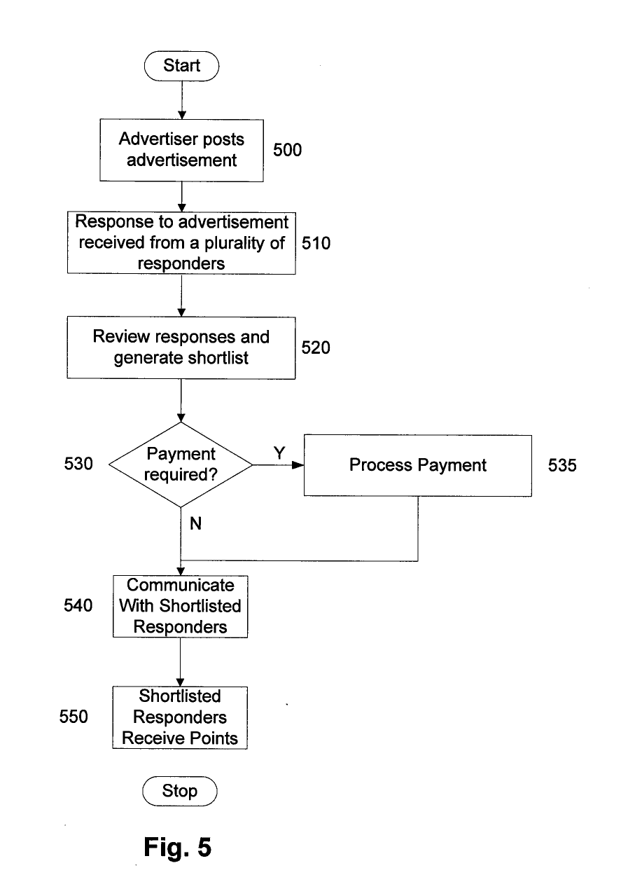

In particular, FIG. 1A shows at step 100, advertising information is provided by an advertiser. At step 110 a plurality of responses (generally associated with the provided advertising information) are received from a plurality of responders. At step 120, a shortlist of responders is determined and awarded accordingly. It will be appreciated that the steps of method 101 can be performed in a number of ways, examples of which are described below in accordance with FIG. 5.

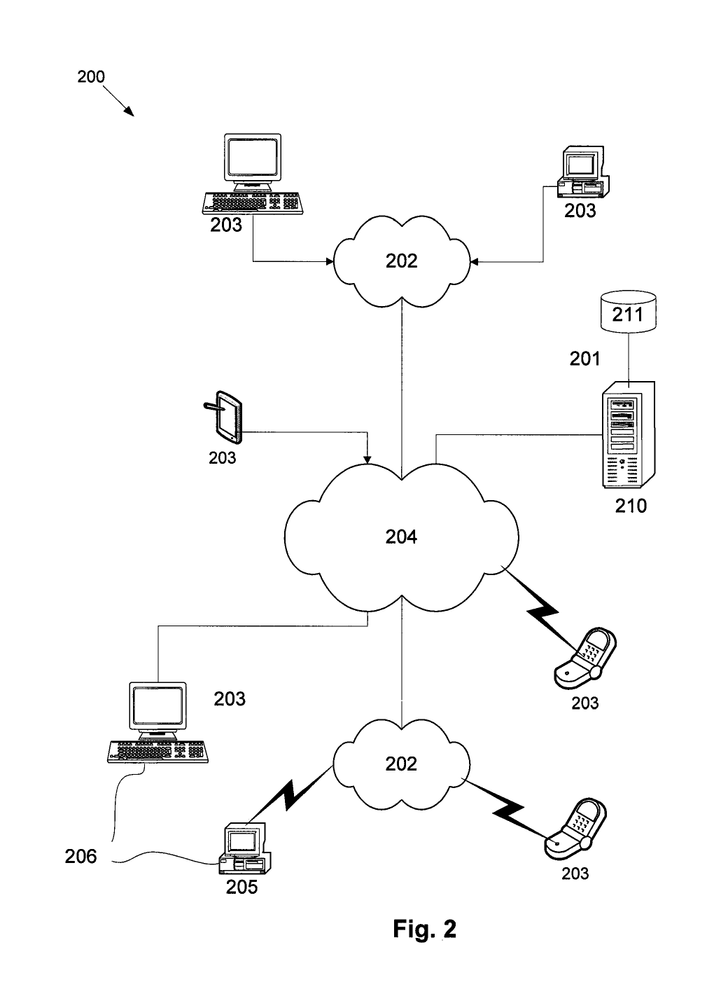

As mentioned, the method 101 of FIG. 1 can be performed using a distributed processing system 200, an example of which will now be described with reference to FIG. 2.

In this example, the distributed processing system 200 includes a base station 201, in the form of a server processing system 201, in data communication with a plurality of end stations 206. The end stations 206 include an advertiser processing system 203 and a plurality of responder processing systems 205. Generally, the distributed processing system 200 can include a plurality of advertiser processing systems 203 in data communication with a plurality of responder processing systems 205. The advertiser processing system 203 and the responder processing systems 205 are in data communication with the server processing system 201 via a communications network 202, such as the Internet, and/or via communications networks 204, such as local area networks (LANs), or wide area networks (WANs). It will be appreciated that the LANs 204 may form an internal network at a specific location.

The server processing system 201 can include one or more processing systems 210, optionally coupled to one or more databases 211. In use, the processing system 210 can be configured to receive data from the advertiser processing system 203 and the responder processing system 205, which can be stored in a data store such as a database 211. Additional data can be generated by the server processing system 201 and stored in the database 211.

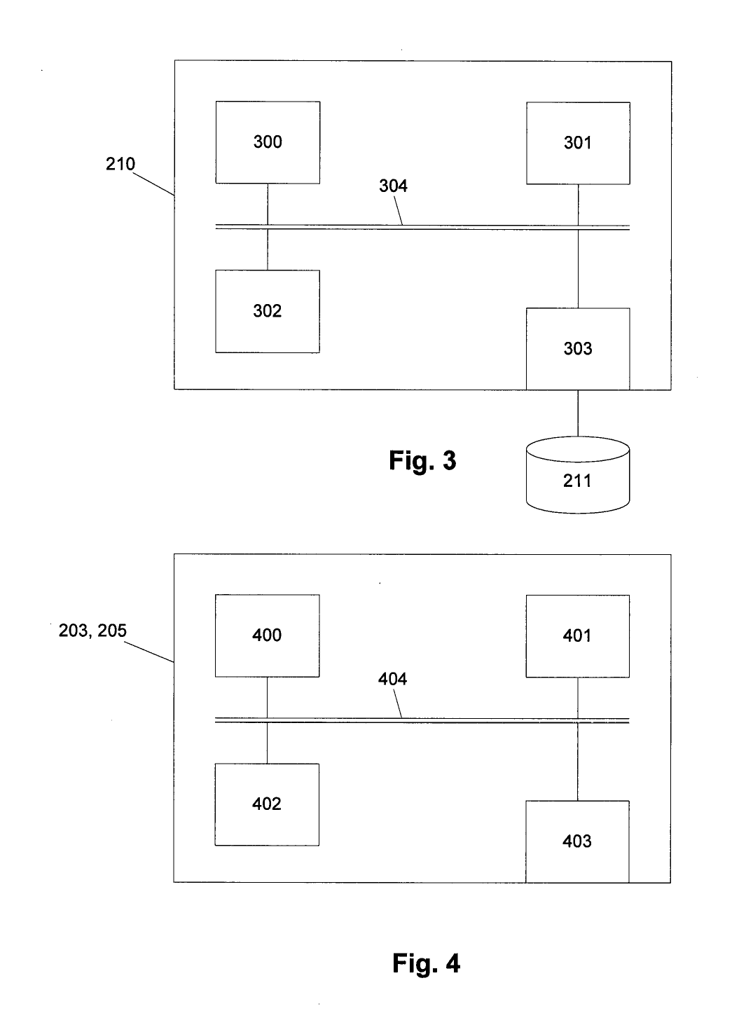

Accordingly, any form of suitable processing system 210 may be used. An example is shown in FIG. 3. In this example, the processing system 210 includes at least a processor 300, a memory 301, an input/output (I/O) device 302, such as a keyboard, and display, and an external interface 303, coupled together via a bus 304 as shown.

Accordingly, it will be appreciated that the processing system 210 may be formed from any suitable processing system, such as a suitably programmed PC, Internet terminal, lap-top, hand-held PC, or the like, which is typically operating applications software to enable data transfer and in some cases web-hosting and file transfer protocol (FTP) functionality.

Similarly, the end stations 203, 205 are typically adapted to communicate with the processing system 210 positioned at the base station 201 to allow users to view and provide advertising information and/or responses to advertising information. It will be appreciated that this can allow for a number of different forms of end stations 203, 205 to be used. It will be appreciated throughout the description herein that the processing system 210 can operate simultaneously as one of the advertiser processing systems 203 and one of the responder processing systems 205 of the distributed processing system 200 depending upon the actions performed by the respective user at the processing system 210.

An example of a suitable end station 203, 205 is shown in FIG. 4. As shown the end station 203, 205 includes a processor 400, a memory 401, an input/output device 402 such as a keyboard and display, and an external interface 403 coupled together via a bus 404, as shown. An internal interface can also be provided to allow the end station 203, 205 to be coupled to one of the communications networks 202, 204, and accordingly, this may be in the form of a network interface card, or the like.

In use, the processor 400 is adapted to communicate with the processing system 210 provided in the server processing system 201 via the communications networks 202, 204.

Accordingly, it will be appreciated that the end stations 203, 205 may be formed from any suitable processing system, such as a suitably programmed PC, Internet terminal, lap-top, hand-held PC, smart phone, PDA, web server, or the like, which is typically operating applications software to enable data transfer and in some cases web-browsing.

Referring to FIG. 1B there is shown a more detailed example of a method of providing the advertising service. In particular, at step 130, the method 131 includes transferring, from the advertiser processing system 203 to the server processing system 201, advertising information for publishing an advertisement to the plurality of responder processing systems 205. At step 140, the method 131 includes receiving, at the server processing system 201 from at least some of the responder processing systems 205, a plurality of responses. At step 150, the method 131 includes forwarding, from the server processing system 201 to the advertiser processing system 203, the plurality of responses. At step 160, the method 131 includes transferring, from the advertiser processing system 203 to the server processing system 201, shortlist data indicative of a shortlist of the responders who responded. At step 170, the method 131 includes the server processing system 201 determining whether payment is required and processes the same, if required, which then at step 180, permits the advertiser at the advertiser processing system 203 to communicate with the shortlisted responder at the responder processing system 205 via the server processing system 201. At step 190, the server processing system 201 awards the responders shortlisted.

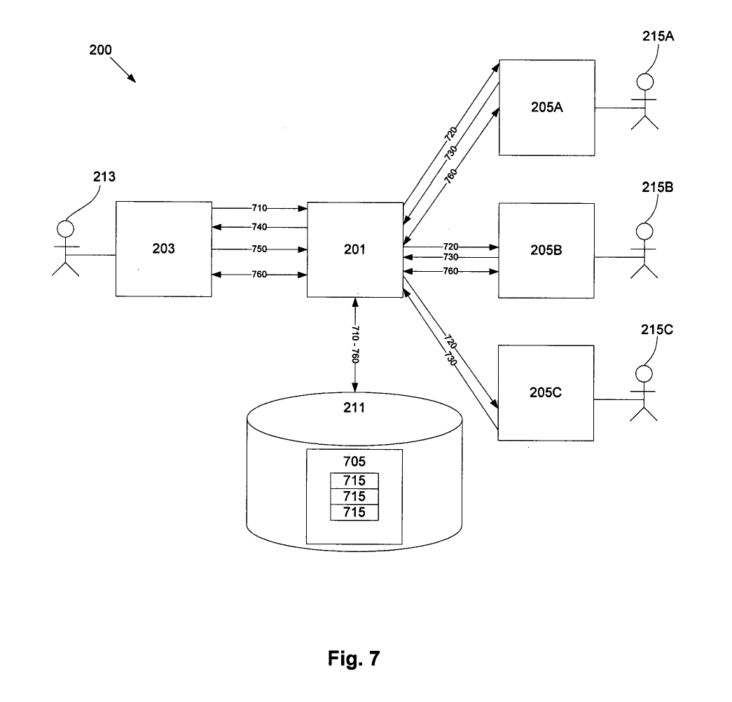

As described herein, there are a number of options to the process of receiving responses, shortlisting responders, determining payment, enabling communication between an advertiser and a shortlisted responder, and awarding points. One example is described in FIG. 5. For the purposes of clarity, the method described in relation to FIG. 5 discusses an example where the server processing system 201 hosts a website which is viewable and interactable by the users at the respective end stations 206. FIG. 5 will also be described with reference to the system block diagram provided in FIG. 7.

In FIG. 5, at step 500, an advertiser 213 posts one or more advertisements 715 on a website 705. In one form, the advertiser 213 uses one or more input devices of the advertiser processing system 203, such as a keyboard and/or mouse, to generate the advertising information 710 to the server processing system 201. In a specific embodiment, the server processing system 201 may present a form which the advertising processing system 203 displays as a webpage which the advertiser 213 completes to forward, to the server processing system 201, the advertising information 710. The server processing system 201 uses the advertising information 710 received from the advertiser processing system 203 to generate the advertisement 715 which is posted on the website 705. The website 705 is then viewed 720 by each responder 215A, 215B, 215C at least each respective responder processing systems 205A, 205B, 205C.

At step 510, response data 740 indicative of a plurality of responses 730 to the advertisements 715 are received from the plurality of responders 215A, 215B, 215C via the website 715. Specifically, the advertiser 213 may login to the website 705 to access a respective advertiser account and review each response 730 received. Each response 730 generally includes information in relation to an offer made by the respective responder 215. In particular, in the event that the advertisement is a request for supply of a product, the response data 730 may be indicative of content related to the specific product which the responder 215 has to offer to the advertiser 213. However, in the event that the advertisement 715 is a product for offer, each responder response 730 may include content related to potential offers to purchase the product. As will be appreciated, the product can be a good or a service. As such, in the event that the product is a good, then the advertisement may be indicative of the supply the good wherein the responses are offers to purchase the good, or the advertisement may be indicative of the request to supply the good wherein the responses are offers to supply the good. In the event that the product is a service, then the advertisement may be indicative of the supply of the service wherein the responses are offers to purchase the service, or the advertisement may be indicative of the request for supply of the service wherein the responses are offers to supply the service.

At step 520, the advertiser 213 can review responses 730 received and prepares, via the input device(s) of the advertiser processing system, a shortlist of responders 215. In particular, shortlist data 750 can be transferred from the advertiser processing system 203 to the server processing system 201 indicating the one or more responders 215 who have been shortlisted by the advertiser 213 which he/she may wish to discuss the respective offer indicated by the respective response 730. The server processing system can then selectively enable communication with one or more of the responders, as will be explained in more detail below.

The interface of the website which is displayed by the advertiser processing system can provide an indication as to whether the advertiser is able to freely communicate with each responder, if shortlisted, or whether the responder is a restricted responder. If the responder is a restricted responder, the advertiser may be required to incur some charge in order to communicate with the restricted responder via the server processing system. In one embodiment, as each responder is shortlisted, data is transferred to the server indicative of the newly added responder to the shortlist. The server processing system then uses records stored in the data store to determine whether the advertiser is required to be charged for communicating with the responder via the processing system, wherein data is transferred back to the advertiser processing system and an indication dynamically displayed via the interface of the website indicative of any charges incurred. As will be discussed in further detail below, the advertising service may provide a threshold allowance of restricted responders which the user is able to communicate with over a predefined period (i.e. the user may be able to communicate with 5 restricted responders over a 1 month period). As such, records stored in the data store are generally required to be queried to determine if the advertiser will be charged to communicate, via the server processing system, with selected responders.

In another variation, the advertiser may be provided no indication as to which responders the advertiser is free to communicate therewith. However, once a shortlist by the advertiser has been generated and transferred to the server processing system, the advertiser may then be made aware as to which responders require some form of charge to be incurred in order to enable communication via the server processing system. The advertiser is then able to select whether the charge is to be incurred for all, some, or none, of the responders which require some form of charge to be incurred.

At step 530, the method includes the server processing system determining if payment is required by at least one of the advertiser 213 or the responder 215 to enable the advertiser to contact one or more of the responders 213. In the event of a positive determination that payment is required, the method includes, at step 535, the server processing system processes the payment and then proceeds to step 540. In the event of a negative determination to step 530, the method proceeds to step 540.

At step 540, the advertiser is then able to communicate 760 with each of the responders and each of the shortlisted responders is awarded. The communication may take the form of one or more messages 760 sent between the advertiser and the one or more responders shortlisted via the server processing system 201. The website may provide a communication interface, such as one or more text boxes which the advertiser can input data, such as text or the like, to send to the responder, via the server processing system. The responder can then login to the advertising service website similarly to the advertiser, and retrieve the communication received from the advertiser. The responder is then able to respond to the communication from the advertiser similarly to the process of the advertiser communicating with the responder.

At step 550, each shortlisted responder is then awarded. The award may take the form of one or more virtual points or a monetary credit to an account associated with the responder which is operated and maintained by the server processing system 201. The award may be redeemed either for a financial incentive or used within the system 200, as will be explained in further detail below.

Step 530 can be performed in a number of ways, as will be discussed below in more detail.

In one form, the server processing system 201 can apply a series of payment rules, stored in the data store of the server processing system, to determine if the advertiser 213 can freely communicate with the responder or needs to incur some charge to communicate, via the server processing system, with responders who responded. As will be appreciated from the above, the charge incurred by either the responder or the advertiser may be a monetary charge or a debit of a virtual token which is stored in records of the data store of the server processing system.

In the event that responders 215 have responded, the server processing system 201 or the advertiser 213, via the advertiser processing system 203, may shortlist a portion of the responders 215. In one form, the advertiser is freely able to communicate with particular responders due to the responder either having purchased a subscription or willing to have an account debited to enable the communication.

However, other responders may be restricted responders, wherein a restricted responder has not purchased a subscription and is not willing to incur a charge to enable communication to be received from the advertiser. As such, the advertiser can be restricted from communicating freely with restricted responders. The server processing system 201 can maintain a threshold number indicative of an allowance of restricted responders which the advertiser is permitted to freely communicate therewith over a predefined time period. A counter is generally maintained in records stored in the data store indicative of the remaining amount of allowance for the specific user. Each restricted responder which the advertiser selects without incurring payment results in the counter being decremented. If the counter is decremented to zero, the server processing system 201 restricts the advertiser from freely communicating, via the server processing system 201, with any further restricted responders until payment is processed by the server processing system 201.

In one form, in the event that a particular responder 215 has purchased a subscription to use the advertising service, the server processing system 201 is configured to enable the advertiser 213 to freely communicate with the respective subscribing responder 215. The server processing system may perform a query against records stored in the data stored in the database 211 to determine whether this instance is applicable.

Steps 540 and 550 can also be performed in a number of ways. In one form, the server processing system 201, upon receiving the subscription data 750 indicative of the one or more shortlisted responders 215, awards the shortlisted responder upon payment being received from the advertiser and processed by the server processing system 201. In another form, the server processing system 201 may be configured to, upon payment, allow the advertiser 213 to send a message to the responder 215. Once a reply is received from the responder 215, an award may then be provided to the responder 215 as a valid and worthy responder 215.

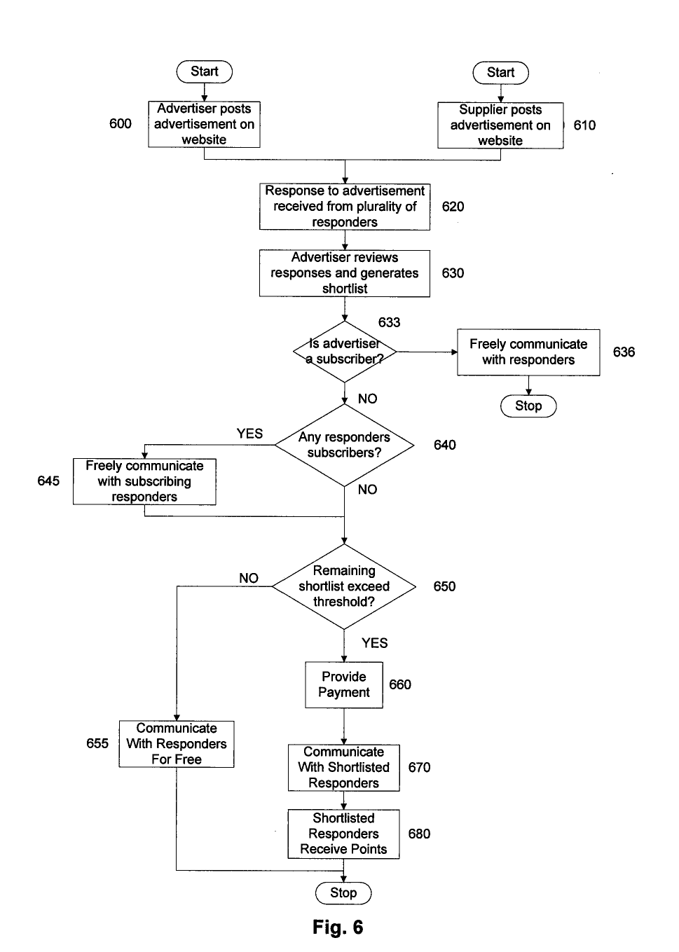

A further example of advertising, will now be described in more detail with respect to FIG. 6.

The process of FIG. 6 begins with the advertiser 213 transferring advertiser information 710 to the server processing system 201 which results in an advertisement 715 being posted on the website 705. In this example, we have two advertising entities 213 posting advertisements 715, in particular a job advertiser or hirer posting advertisements for a certain service at step 600 and a service provider or supplier posting advertisements for a certain service at step 610. According to one example, the website 705 can be hosted on the server processing system 201. At step 620 responses 730 to the advertisement 715 are received from a plurality of responders 215, via the website 705.

At step 630 an advertiser 213 can review responses received and shortlists a number of responders 215. At step 633, if the advertiser itself has purchased a subscription to use the system 200, then the advertiser 213 is able to freely communicate with any number of responders at step 636. At step 640, if any of the responders have purchased a subscription to use the system 200, then the advertiser 213 is able to freely communicate with the respective responder 215 at step 645.

At step 650, the server processing system 201 determines whether the number of responders 215 remaining in the shortlist (i.e. restricted responders) is greater than the permitted current allowance, wherein the current allowance for the user is stored in the data store of the server processing system 201 and configurable by an operator of the server processing system 201. In this example, this threshold allowance is indicative of the number of responders 215 which the advertiser 213 can freely communicate with over a period of time. Upon the advertiser 213 selecting a responder 215 to freely communicate therewith, via the server processing system 201, a counter indicative of the current remaining restricted responders which the advertiser can communicate therewith is decremented. Once the advertiser 213 has exhausted the permitted restricted responder allowance, payment is required by the advertiser to be processed by the server processing system 201. After the time period has expired, the server processing system 210 is configured to reset the threshold back to an original value for a new predefined period of time, thereby allowing the advertiser to freely communicate with one or more responders who are shortlisted accordingly.

However, if the number of restricted responders 215 shortlisted is greater than the allowance threshold, then the process continues to step 660, where the threshold number of restricted respondents is still free to communicate with, via the server processing system, but communication with the remaining number of responders 215 require some form of payment by the advertiser 213 which is processed by the server processing system 201. The payment opens a communication channel between the advertiser 213 and the shortlisted responders 215, at step 670, via the server processing system.

Notably, in this particular example, the payment made by the advertiser is dependant on the number of responders 215 shortlisted and the relevant service. At step 680 the shortlisted responders 215 are awarded an with an incentive, such as points or credit in an account stored in the data store of the server processing system, as a reward for having replied with relevant information to have been shortlisted by the advertiser. The award can be redeemed by the responders 215 by purchasing products or placing their own advertisements on the website, or may receive other financial benefits.

Once the communication channel is open between the responder 215 and advertiser 213, there is no limit to the number of messages they can exchange for the particular product concerned.

The website 705 provides an online environment where:

1. a buyer (or hirer) shortlists one or more sellers (or suppliers). The buyer then pays (either monetarily or via a loyalty scheme such as collected points or the like) to communicate with the shortlisted seller, wherein the shortlisted seller (or the potential seller) earns points as a reward for providing sufficient content that enabled the seller to be shortlisted.

2. a seller (or provider) shortlists one or more buyers (or hirers). The seller then pays (either monetarily or via a loyalty scheme such as collected points or the like) to communicate with the shortlisted buyer and the shortlisted buyer (or the potential hirer) earns points as a reward for providing sufficient content that enabled the buyer to be shortlisted.

3. the buyer or seller on a ‘pay-per-response-to-advertisement’ payment model do not pay for a response, if the responder has purchased a subscription to use the advertising service, such as an annual subscription.

4. the buyer and seller are equal, as the functionalities available to each are the same.

Furthermore, the hirer and supplier are two entities that can place advertisements for a specific service on a website specifying rate/s, location/s, specific date or days in the week.

It will be appreciated that a user can be both a hirer and a supplier, however for different advertisements.

In one option, the allowance threshold that is stored by the server processing system to enable the advertiser to enable communication with a limited number of restricted responders over a predefined time period can be specific for a particular industry of products. For example, the data store may store data indicative of a counter for multiple industries for each advertiser. As such, when the advertiser shortlists a restricted responder to communicate therewith via the server processing system, the server processing system queries records of the data store to determine the industry classification for the advertiser's advertisement, and then decrements the counter associated with the determine industry classification. If for example, the advertiser has posted a second advertisement via the server processing system which is classified in a different industry, the data store has a different allocation threshold for this respective advertisement. However, if the second advertisement is in the same industry, the same allocation threshold applies as for the first advertisement.

According to yet a further example, each user can have a user page viewable via the website 705, wherein data associated with each user page is stored in the data store of the server processing system. In addition to permitting the user to provide a self description, their caption, logo, success stories, references, the page also permits other users to send an expression of interest in a specific industry service to the user. The user then has the option of posting a new advertisement for hiring or supplying depending on the interest expressed or can decline the expression of interest as well. Furthermore, the user page can also allow other users on the site to sign-up to receive updates on changes to a particular user's data such as advertisements and news.

It will be appreciated that the system and method described herein can provide numerous advantages.

According to one example, the reward to potential buyers and sellers can help to increase the quality of products, such as goods and/or services, provided by a business. Additionally, the system and method described herein provides for a uniform method to recruit both professional and non-professional jobs and services. Furthermore, the system and method can be implemented as an online platform where the functionalities available to the buyer are also available to the seller and vice-versa. Feedback on both is possible and available for all to view, which can be advantages for future users of the system/method.

The system and method described can provide a notification mechanism (similar to or like an online noticeboard) where the rate, location, days or date and time can be advertised and any changes to this data can be sent as an update email to all users that have selected to be notified of changes on a particular user.

Furthermore, as a buyer can shortlist and pay to communicate with an unlimited number of sellers, the buyer is not restricted to completing the business transaction with just one seller. Thus, the buyer may find more than one appropriate seller and complete a business transaction individually with each appropriate seller the buyer chooses to.

Thus, there is provided herein a system/method, which can be implemented to provide an avenue for users looking for work and/or hire services, or businesses looking for potential employees and/or service providers, and/or business leads. Accordingly, the system and method described herein can provide an online environment for business development, recruitment and the hiring and providing of goods/services.

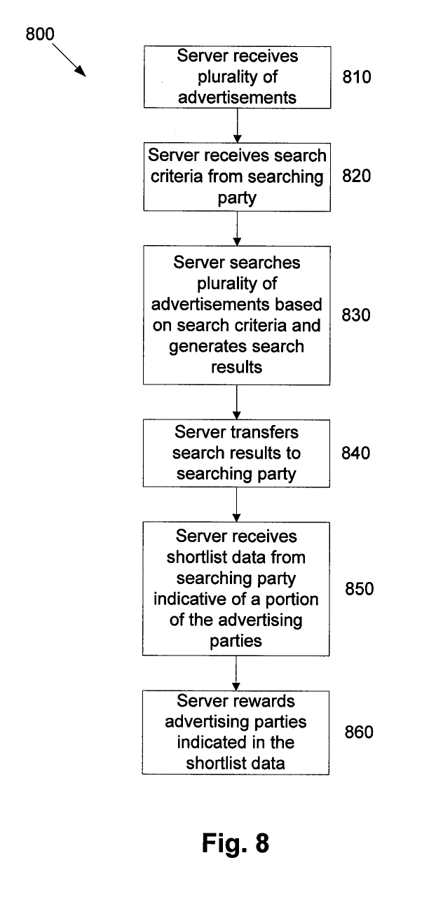

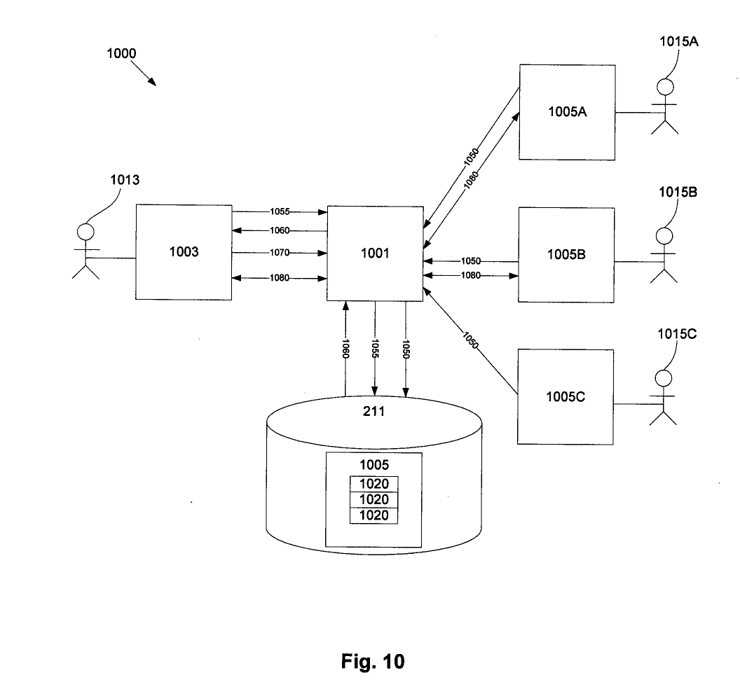

Referring to FIG. 8 there is shown a flowchart representing an example method of a searching party searching for an advertisement using a server processing system. FIG. 8 will be described in combination with FIG. 10 which illustrates an example system for enabling a searching party to conduct a search for an advertisement. It will be appreciated that the server processing system 1001 described in the current example can be the same server processing system 201 described in previous embodiments.

In particular, at step 810, the method 800 includes the server processing system 201 receiving a plurality of advertisements 1050 from a plurality of advertising parties 1015A, 1015B, 1015C (generally referred to as 1015). In particular, the advertising parties 1015 may be advertising the supply of a good or service. Additionally or alternatively, the advertising parties 1015 may be advertising a request for supply of a good or service. Generally, the plurality of advertisements 1050 are stored in the memory such as a database 1011 which could be the same database as database 211 as described above in other embodiments. The server processing system 1001 may also perform an indexation process by indexing each advertisement 1050 when storing the data in the database 1011 for purposes of allowing efficient searching. Generally, each advertising party operates an advertising party processing system 1005A, 1005B, 1005C (generally referred to as 1005) to transfer the advertisement 1050 to the server processing system 1001.

At step 820, the method 800 includes the server processing system 1001 receiving from a searching party 1013, search criteria 1055. For example, the searching party may be seeking a nanny in Sydney and therefore the search criteria may be “nanny and Sydney”. The searching party 1013 generally inputs the search criteria 1055 via a searching party processing system 1003 which is in data communication with the server processing system 1001, wherein the search criteria 1055 are transferred from the searching party processing system 1003 to the server processing system 201. As described in previous embodiments, the server processing system 1001 may present transfer data to the searching party processing system 1003 which is indicative of a website 1007 including a search form enabling the searching party 1013 to submit the search criteria accordingly to the server processing system 1001.

At step 830, the method 800 includes the server processing system 1001 generating search results 1060 by searching the plurality of advertisements 1050 based upon the search criteria 1055, wherein the search results 1050 include one or more advertisements 1050 by one or more advertising parties 1015 which are considered relevant to the search criteria 1055. Generally, the search results include a plurality of advertisements 1050 that meet the search criteria 1055.

At step 840, the server processing system 1001 forwards, to the searching party 1013, the search results 1060. The search results 1060 are generally forwarded to the searching party processing system 1003 for presentation to the searching party 1013.

At step 850, the server processing system 1001 receives from the searching party 1013, shortlist data 1070 indicative of a portion of the advertising parties 1015 which the searching party 1013 shortlisted.

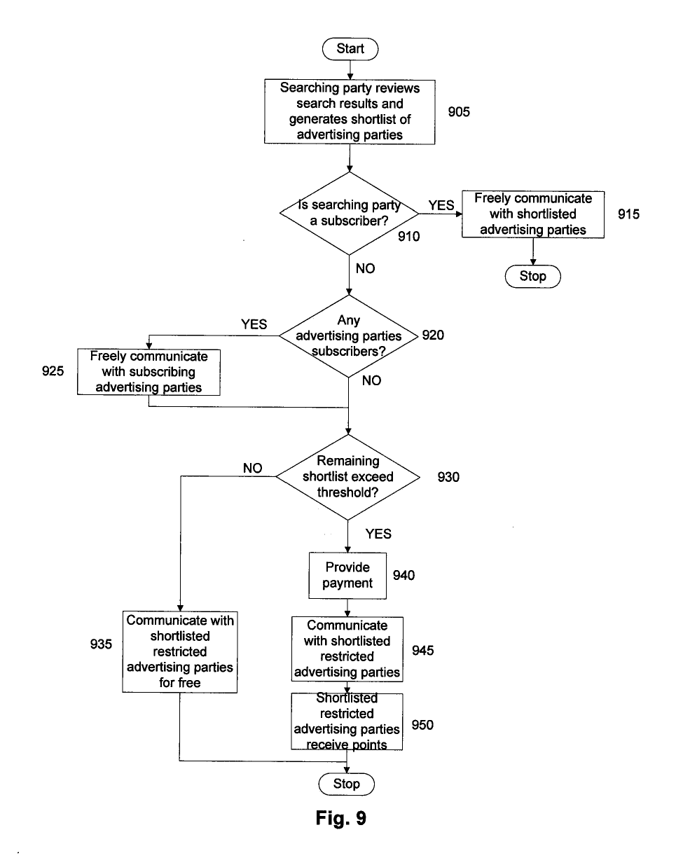

At step 860, the server processing system 1001 awards the portion of the advertising parties 1015 who have been shortlisted. The shortlisted advertisers 1015 may be awarded similarly as discussed in previous embodiments discussing shortlisted responders 750. As will be discussed in relation to FIG. 9, a communication channel 1080 can be established between the shortlisted advertising parties 1015A, 1015B and the searching party 1013.

Referring to FIG. 9 there is shown a flowchart representing an example method relating to enabling communication between a searching party 1013 and one or more shortlisted advertising parties 1015.

In particular, at step 905, the method includes the searching party 1013 reviewing, using the searching party processing system 1003, the search results and generating a shortlist of advertising parties 1015 which is then transferred to the server processing system. It will be appreciated that this step in equivalent to step 840 and 850 from FIG. 8.

At step 910, the method includes the server processing system determining if the searching party 1013 is a subscriber which is determined using subscription records stored in the database 1011. In the event that the searching party 1013 is a subscriber, the method proceeds to step 915, wherein the searching party is able to freely communicate with any of the shortlisted advertising parties via the server processing system as described in previous examples. Otherwise, the method proceeds to step 920.

At step 920, the method includes the server processing system 1001 determining if any of the shortlisted advertising parties are subscribers. In the event of a negative determination, the method proceeds to step 930. In the event of a positive determination, the method includes at step 925 the searching party being freely enabled to communicate with the subscribing advertising parties via the server processing system 1001 accordingly. The method then proceeds to step 930.

At step 930, the method includes the server processing system 1001 determining if the number of remaining advertising parties 1015 (i.e., restricted advertisers) exceed a threshold, wherein a restricted advertiser has not purchased a subscription and is not willing to incur a charge to enable communication to be received from the searching party. The threshold is stored in setting data maintained in the database or memory of the server processing system 1001 and can be configurable. In the event that the number of remaining restricted advertising parties 1015 exceeds a threshold, the method proceeds to step 940. Otherwise, the method proceeds to step 935. In this example, this threshold allowance is indicative of the number of advertising parties 1015 which the searching party 1013 can freely communicate with over a period of time. Upon the searching party 1013 selecting an advertising party 1015 to freely communicate therewith, via the server processing system 1001, the a counter indicative of the current remaining restricted advertising parties which the searching party 1015 can communicate therewith is decremented. Once the searching party 1013 has exhausted the permitted restricted advertising party allowance, payment is required by the searching party to be processed by the server processing system 1001. Payment may occur via debiting a searching party account in the event that sufficient credit is available to enable communication to be established. After the time period has expired, the server processing system 1001 is configured to reset the threshold back to an original value for a new predefined period of time, thereby allowing the searching party to freely communicate with one or more advertising parties 1015 who are shortlisted accordingly.

At step 935, the method includes the server processing system 1001 enabling the searching party 1013 to freely communicate with the restricted advertising parties 1015 in the shortlist via the server processing system 1001. The method then ends.

At step 940, the method includes the searching party 1013 providing payment to enable communication with the remaining restricted advertising parties 1015 who have been shortlisted. Generally the payment is performed electronically using the server processing system 1001 or an associated payment gateway processing system. Upon successful processing of the payment, the server processing system 1001 enables communication, via the server processing system 1001, between the searching party 1013 and the one or more remaining restricted advertising parties 1015 who were shortlisted.

At step 950, the shortlisted advertising parties receive points for being shortlisted. This step is performed similarly to that of 680.

### Further Examples

The method and system described herein can be implemented, according to one particular example, via a website. The website can have numerous features, some of which are further described below.

### Home Page

The home page can include search for providers and hirers, a generic keyword search in addition to and advanced search. An advanced search mechanism can also be provided via a separate page. The home page can also include a video about the site, images, etc. Furthermore, links to separate pages can also be provided on the home page. Industry links and searches can also be provided on this page. Furthermore, lists of the latest hiring and providing advertisements with links to specific details can also be provided.

### Registration

Users can be asked to register with a unique email ID and password. Users can also have a display name, although they are typically uniquely identified internally within the system by their email ID alone.

### Account Settings

Each user can customise their account settings, including other settings such as customising their preference with respect to alerts which can be automatically sent by the system, such as for example, the mode of receiving the message (i.e. email, SMS, only if they have bought a service that support SMS), the frequency of these alerts (i.e. weekly, monthly) with the option for the user to stop receiving that particular alert, and the option to specify a stop on receiving alerts from specific users.

### Error Messaging to User

Error messages can be provided to the user in case of any incorrect data entry by the user, or the like.

### Search and Search Results

According to one example, a user can perform several types of searches from the home page. These can include keyword searches, which can search on numerous fields in the database.

A hyperlink can be provided from an industries list on the home page, which can allow searching on all hiring and providing advertisements and users who operate in a particular industry. Notably a user who operates in an industry can be determined from the user history of advertisements. Furthermore, each service in each industry can also provide a hyperlink to hiring, providing and user advertisements for that service.

An advanced search option can be provided on a separate page, one each for provider and hirer that can search specific locations, right down to suburb, and surrounding areas, specific salary or rates and specific dates.

Once a search is performed, a search results display can be provided which includes the ID, User Last Active Date, Suburb, State, Country, Rate, Start/On Date, and a caption with two lines from comments. A user may then be able to sort on any field except caption and comments.

Notably, although, in one particular example, expired advertisements can still be searched on via advanced search criteria (when a user enters specific advertisement ID), these advertisements may still list and display the original content but with a watermark of ‘expired’.

### Advertisement Content

A user posting an advertisement can provide to the server processing system information such as a caption, picture, start and end dates, specific days in the week and times or specific dates and times, one or more rates or salary conditions (i.e. rate per hour, day, week, month, year), one or more locations (i.e. a few suburbs or the whole state or the whole country or many countries). A user may also be able to add one or more categories of industry and service under which an advertisement is able to appear in search results. Additionally, the system may be able to compute the duration of hiring or providing based on dates entered by a user.

According to one particular example, after placing an advertisement, responses to that advertisement can be shown publicly as they are received, with a counter on number of responses, number of days for the advertisement to expire and number of times this advertisement has been viewed. Each response can also show how long it has been since the response was received (for example, 2 mins ago, etc.). Notably, subsequent messages between users can be kept private. An advertisement can be made to expire in ‘N’ weeks. Thus, after a user logs in, for each advert, there can be provided an additional field to show whether that advert has expired or not.

According to a further example, once an advertisement is posted, a user may not necessarily be able to update that advertisement. However, a user may be able to save an uncompleted advertisement and post a completed advertisement to public.

### Advertisement Responses

User can send a response to an advertisement and view status, such as whether shortlisted on that advertisement. If shortlisted, user can view points earned and provide and receive feedback.

### Outgoing Emails

The server processing system may be configured to generate a regular email, or the like, which includes all of the new advertisements that have been placed (the advertisements being separated by hiring and providing advertisements) to all registered users, the frequency of which is user configurable

Furthermore, a user specific broadcast email can also be supported so that each user's following can be instantly notified of changes on a particular user's data.

### Selling

According to a particular example, a product set including a number of products can be made available to users (for example, one or more adverts and annual subscription packages).

Thus, a user may be able to use points or cash to buy these products. For example, the products can include offering SMS alerts, where alerts normally sent via email can also be sent via SMS.

As discussed herein there are a two methods in which an advertisement can be placed. According to one example, a payment is made upfront for one of the products and then it is free to post advertisements and communicate with unlimited number of responders.

According to another example, advertisements are posted for free, responses are received and reviewed for free as well, and a payment is made only if any of the responders are worth paying for to proceed ahead and communicate with. Additionally the responder may be on an ‘annual subscription’ plan, in which case, it is free to the advertiser to communicate with this responder. This is further described below.

All advertisements run for ‘W’ weeks. ‘N’ responses of the user's choice are free in a ‘Y’ week period, for a particular industry-service combination, ‘N’ responses free for hiring and ‘N’ responses free for providing advertisements. Each of the rest of the responses cost $‘X’ or ‘P’ points to shortlist. In one particular example, if a user pays cash, the minimum a user can buy is anything worth $10. ‘X’, ‘P’ and ‘N’ varies for each industry-service and is different again for hiring and providing. If a user places a second hiring advertisement in the same industry-service within a ‘Y week period of the first advertisement, ‘N’ responses across the advertisements will be free, after which charges apply. The free counter is reset after the end of ‘Y’ week date.

### Shortlisting

Once responses are received in association with an advertisement, the advertiser to be able to review the responses and shortlist those the advertiser would like to communicate with.

According to one particular example, if the advertiser has paid upfront for a product, the advertiser is able to communicate directly with all those shortlisted applicants, their references (if available) and past feedback providers. In this particular example, there are no limits to the number of messages that can be exchanged.

Alternatively, if the advertiser has not paid upfront for a product, such as a subscription, the advertiser then provides payment for each applicant response to be able to then communicate with the respondent, their referees and their past feedback providers. In one form, the advertiser is only debited once a response has been received. For example, if the advertiser shortlists five responders, and only three respond, the advertiser is only debited for three responders rather than five. The advertiser though may not need to pay for each responder; some may be free to communicate with. A fixed number of free communication channels may be offered in a fixed period, which can be provided for a certain service with other conditions associated therewith. Also if the applicant has paid for a product such as an ‘annual subscription’ to the same website, then that applicant is free to communicate with.

Each shortlisted applicant that the advertiser has purchased gets S points as a reward for having responded with sufficient detail to have enabled the applicant become shortlisted. Upon payment, the shortlisted applicant and advertiser can exchange any number of messages.

Notably, the initial responses received can be viewed by other users of the system and thus cannot generally contain any phone numbers, street, email or web addresses. Thus, the server processing system applies a filtering program upon receipt of the advertisement information which scans for these identifiers and removes this data, if provided by the advertiser.

### Messaging Between Users

The website can provide functionality for messaging between users (i.e. registered users) of the site. The message can include “From”, “Date”, “Time”, “Subject”, and “Advertisement reference” as fields. Users are able to view a message such that all other messages between the two users are viewable, with a user being able to see which are the newer messages. Furthermore, a user is typically able to move between the messages being viewed easily.

According to a further example, users may also be able to see another user when online and exchange instant messages. Thus, there can be provided against each user, an indication of whether that user is online at a particular moment and a ability to communicate with another user instantly and otherwise via messages.

### Feedback

According to another example, shortlisted applicants and the advertiser can provide feedback on each other by providing a number score and a comment, to be available for the public to view. Furthermore, a short feedback and long feedback can also be provided. Short feedback consist of 1 score between 1 and 5 and a comment. Long feedback additionally consists of 5 scores between 1 and 5, which is averaged out to form 1 score, called the user rating score.

Feedback will not be accepted unless the feedback provider's phone number is available at the server processing system, as they may be contacted to check this feedback, if required.

The user rating score received at each advertisement level can then be used to arrive at the average score for that industry-service combination, one for hiring and another for providing. The average of these two scores is used to arrive at the one score for each user. User to be able to drill down into the data that contributed to that score, such as from which user, rating obtained, comments and other feedback for each advertisement. Notably, if an advert expires in ‘W’ weeks, feedback is permitted for a certain number of months after the advert expires.

### Points Earning and Redemption

As noted herein, a user can earn an award, such as points, in accordance with numerous methods. These include when a user is shortlisted by an advertiser in response to an advertisement, and when a user introduces a new user to the system. On the first paid transaction of this new user, the user that introduced the new user is given points.

Furthermore, users can redeem points in all instances where payment is asked for.

Thus, a user to be able to view their points earned, points balance and the detail showing which transactions contributed to that balance.

### Networks and Lists

According to a further example, a user of the website can have stored in the data store 211 data indicative of a network of contacts. The network is generally made up of one or more lists. Each list includes contacts for a particular industry-service combination. For example, a user can have one list for ‘Cleaning’ and another for ‘Cooking’ and although the same contact can appear on both lists, the contact is only counted once by the network.

In one particular example, all listed contacts are free to contact and shortlist. However, to be placed onto the list, the contact must have been a shortlisted responder that the user paid for and is free to communicate with for a period of time, such as the next 12 months, or, if on a certain type of product such as an annual subscription payment model, the user can add any number of other users to this list, who are free to communicate with until the user's subscription lasts.

According to yet a further example, one small comment box and one large comment box can be provided with each contact on the list, to enter their own data such as contact data if desired. These comment boxes may be maintained as private to each user.

Furthermore, there can also be provided, against each user, an indication of whether that user is online at that particular moment, and thus the ability to communicate with the user instantly or otherwise via messages is also provided.

Notably, the industry-service the list is related to and displaynames on list/s can be public by default, although, the user can choose to make individual contacts on the list private or the whole list private (that is, no one else other than the user who created the list can view the list). Furthermore a link from the displayname of contact can be provided to the User Profile Page for that contact.

In yet a further example, each user's public page can list how many networks the user is a part of and to display the lists of the user's network and contact displaynames on those lists.

In yet a further example, the user is able to export contact data to popular file types and programs.

After 12 months since the contact was added to the network, or, the subscription expires, the contact may still form part of the user's contact list, however, the server processing system disables communication tools, such as comment boxes, to restrict the user communicating with the respective contact. However, the user may still be able to transfer a notification such as an expression of interest to the contact.

Notably, non-users of the website can also be added, by just providing an email address or the like, which such that an email can be sent to the non-user, inviting them to join the website and informing them that they can advertise their jobs or services on the site. The invitation can also state that it will be free to contact and shortlist either user by the other for 12 months, which is otherwise a paid functionality on the website.

Furthermore, the new member can be offered an ‘Z’ month's trial membership or ‘M’ points towards their first advertisement. The user issuing the invitation can also be offered ‘Z’ points upon the first paid transaction of the new user, if done within ‘M’ months of issuing the invitation. Notably, users may earn points by inviting anyone (even those they do not know). Although a provision can be provided to bar a user from inviting new users if found to be abusive of that functionality. Generally, a new user invitation lasts for ‘Z’ months, after which, the connection between invitee and inviter is broken.

### Affiliate Sales

A user can sell products from the website and earn a commission on sale made. The commission is a percentage of sale amount. According to one particular example, there are two types of affiliates, normal affiliates and power affiliates.

Any user can become a normal affiliate. Power affiliates are determined by the administration of the website. Typically, affiliates have an account by which they can accept payment and upon registration, they can provide their account information and other information such as address, or the like. The affiliate is usually then assigned an affiliate code.

Thus, affiliates can place banners on their respective websites, and provide other mechanisms for advertising, such as placing a scroller of ‘hiring’ and ‘providing’ advertisements. Accordingly, if a user is directed from an affiliate site, and registers at the website of the system described herein, the affiliate obtains a percentage of commission from the first payment the new user makes at the website.

Affiliates to be able to login and get details of all transactions that have come from their website, such as which have registered, which have paid an amount, how much paid and the date.

According to one particular example, power affiliates are similar to normal affiliates, except that they earn higher rate of commission. Additionally, power affiliates are expected to perform face-to-face sales of products. In order to support this, power affiliates can receive, from a customer and enter the same detail as required in user registration, additionally data on the product bought, amount paid, date paid, mode of payment and the receipt number (if there has been an electronic transaction).

Thus, the power affiliates are able to enter data into the system, and the system provides functionality which can allow for the data to be saved, prior to submission (such as, for example, for times where a receipt number is not immediately available). The submission by the power affiliate can then generate an invitation email to user with link to login into the website. When the new user logs in, all details entered by power affiliate can be shown to user, along with a photo of the affiliate.

Power affiliates can also invite users to the website via the network, where they can either receive points or earn their rates of commission on the first sale made by that new user. The invited user can also receive a standard offer of ‘X’ month's trial membership to the website or ‘N’ points towards their first advertisement.

According to one example, power affiliates can continue to stay as relationship managers with their customers, where they can continue to receive commission not just on the first purchase made by the customer, but on all subsequent purchases as well provided they maintain a certain rating score.

### User Profile Page

Each user of the system can have a separate page, which includes a description of the user. The user may be able to enter a caption, logo, name, description, achievements, success stories/references, pictures, video, news, discount/special offers to members of the website and ability for others to link to their page on the website via banners or text links.

The user profile page can be accessed from many different places on the website. Furthermore, this user profile page can always be visible irrespective of whether the member has current advertisements or not. Thus, a user page can generate interest for a viewer, and can be a link where other users are able to send an expression of interest to this user via the respective user profile page. Additionally, a user page can also list or link to the current and/or expired advertisements by the user. Furthermore, other users can opt-in to stay updated on posts or changes made by this user, in which case, they will receive an email with updates this user has made or can subscribe to an RSS feed. The updates are usually updates to ‘news’ and advertisements

The user profile page can also include a number of counters on the page. These can be used to show different aspects of the user's activity, such as but not limited to a user rating score for hiring and providing, an average response time of this user to reply to messages, number of networks this user appears on, number of users opted-in to receive updates on this user and number of times this user profile page has been viewed.

Thus, according to one particular example, a user may have the ability to receive details associated with each type of counter. For example, a viewer of the user's page may be able to attain the past history of the user and view where the user has been shortlisted, as well as being able to view any associated feedback comments and general score. A viewer of the user's page may also be able to see all other user networks the user appears on (if the user is a public contact, not a private contact on the network). Additionally, the average response time can be computed from after a message has been received in user's inbox to when the user replies, where the duration computed is stored with each message being sent out, and the average can be displayed to all users. For the number of times the user profile page has been viewed, a breakdown by industry service can be provided.

User can save and post news that appears on this user profile page. User can also view this new on a bigger page separately. User can add news items, but cannot update previous news. News to be displayed with time and day as well e.g. 2 mins ago or 2 days ago.

### User Data Scanning

Any data provided by a user in fields such as comments, description, text for pictures and videos and other fields, which are publicly viewable, can be scanned and either amended, masked or deleted if the data provided is not suitable. Non-suitable data, for example, includes providing contact data such as phone numbers, or any type information which is not suitable for the website in general (such as abusive, indecent content or the like).

### Expressions of Interest (EOI)

From a user's profile page, a user can express interest in another user by sending information in relation to the industry, service, and whether this user is interested in:

1. providing the service to the other user;

2. being provided a service by that user;

3. hiring that other user; and/or,

4. being hired by that other user.

A user can view all interactions and/or notifications sent and received and also have the ability to respond to the interaction/notification by declining it or accepting it, in which case the advertisement number posted in response to the EOI can then be sent back to the user.

### Notifications

In one form, the user is able to view which other users have opted in to receive notifications from the respective user. In one form, the user is able to block particular users receiving notifications. Additionally, a user is able to view a list of users which a particular user has opted to receive notifications therefrom. In one form, the user is able to selectively cease receiving notifications from the user.

### Welcome to Logged in User

They system described herein is able to appropriately display advertisements which match a user's need, when a user logs into the website. The need is based on the user's current and expired advertisements. Thus, in this particular example, the system is be able to appropriately display the status and updates on various items relating to the user's data such as, 1) expressions of interest sent and received 2) applications and advertisements posted 3) invitations sent to non-users 4) other users who are following updates on this user's data.

### Additional Points

It will be appreciated that a computer program product can be provided which includes computer executable instructions which when executed by a server processing system configure the server processing system to perform the relevant portion of the method described within this document. Additionally, it will be appreciated that a computer program product can be provided which includes computer executable instructions which when executed by an advertiser processing system configure the advertiser processing system to perform the relevant portion of the method described within this document.

The computer program product can be provided in the form of a computer readable medium. The term “computer program product” as used herein refers to any storage or transmission medium that participates in providing instructions and/or data to the processing system for execution and/or processing. Examples of storage media include floppy disks, magnetic tape, CD-ROM, a hard disk drive, a ROM or integrated circuit, a magneto-optical disk, or a computer readable card such as a PCMCIA card and the like, whether or not such devices are internal or external of the processing system 100. Examples of transmission media include radio or infra-red transmission channels as well as a network connection to another computer or networked device, and the Internet or Intranets including e-mail transmissions and information recorded on Websites and the like.

It will be appreciated that although the present system and method has been described as a website per se, the system and method can be implemented via any technical means which can allow for communication between users. Thus, the application may be available on mobile telecommunication devices, or the like.

Thus, it will be appreciated that the method and system described herein can provide a business application, e-commerce, e-business or any other commerce/business application, where:

1. buyers or sellers advertise, receive responses, shortlist potential sellers or buyers respectively, and accomplish business with a few from the shortlist. According to one particular example, the potential sellers or buyers from the shortlist are rewarded as recognition for their efforts towards being shortlisted. Rewards are via a redeemable point or the like;

2. if the advertiser i.e. a buyer or seller on a ‘pay-per-response to advertisement’ business model receives a response from a seller or buyer respectively, who is on an ‘annual subscription’ model with the same business, then it is free to the advertiser to shortlist that response and communicate with that responder. Thus providing a business model that merges the ‘annual subscription’ model with the ‘pay-per’ (or ‘pay as you go’) model.

Thus, the method and system described herein can allow for shortlised responders to an advertisement to be awarded and receive recognition for taking the time and effort to provide a response to the advertisement (even if unsuccessful).

Furthermore, the method and system described herein can provide incentive for better quality business as potential buyers or sellers are recognised.

The method and system described herein can work in any one or more domains. When two domains or complementary domains are chosen, this method can also provide an equal footing to the entities involved. In some cases, two domains can be made complementary by achieving a common ground between them. According to one particular example, the method presently described can be applied to the domains of 1) recruitment and 2) business development and sales.

It will be appreciated that typically, the two domains of recruitment and business development and sales are distinctly separate. Thus, the presently described system and method can provide a common ground between the two as everything can be viewed as a ‘service’ provided either by a user or for a user. Thus, for example, a seller providing services can also be viewed as a job seeker, and, a buyer hiring services as also be viewed as a job advertiser.

Thus, for example, in recruitment, the buyer is the hirer advertising a job. Job seekers or providers respond to the advertisement with their applications. Hirer prepares a shortlist and eventually hires one or more from the shortlist. Potential providers (or sellers), not finally hired can be recognised for the sufficient and quality information they provided to get shortlisted, with the system and method described herein.

Furthermore, presently in recruitment, it is either the job advertiser or the job seeker that the business is built around i.e. one of them pays to find the other. Typically, the one that does not pay has to spend that extra time in finding out details about the other, details such as feedback by others and work culture. Thus, the presently described method and system can provide a platform that permits an equal footing for both, the job advertiser and the job seeker, with each having access to the same level of detail information as the other. This is particularly relevant in the micro business sector where not much information is available about the micro business in the public domain.

It will be appreciated that this is similar in business development and sales, where the seller is the service provider advertising services. Those who want to avail these services respond to the advertiser. The seller then can prepare a shortlist and eventually provides to one or more from the shortlist. It is evident that the provider (or seller) advertisement typically misses some important detail that the hirer (or buyer) looks for, detail such as unbiased feedback from whom the seller has sold to in the past, rates, suburbs serviced, specific dates and times or specific days in the week and times available.

It is further evident that there is usually no incentive for the potential hirer (or buyer) to take the effort to provide sufficient relevant quality data to the provider, which can prevent problems later down the track. Thus, it will be appreciated that awarding points to the potential hirer (or buyer) can provide the required incentive, leading to better business outcomes for all stakeholders.

It is further presently evident that the job advertising format is for the corporations, recruiters and the like. It is not taking in consideration micro business needs of being able to advertise down to a certain level of detail, such as, locations of work right down to suburb and being able to specify more than 1 location of work; days in the week or specific dates and times of work; rate of pay per hour, day, week, month or year and being able to specify more than 1 rate i.e. rate per week and rate per month; and, whether it is on-site or can be done remotely.

It is further presently evident that micro business needs of being dynamic i.e. being able to operate in many locations and different times and being able to change that, keeping the customer base updated is limited in the current environment, labour intensive and costly.

It is also presently evident that finding a service provider at my price, on my location and at my time is a time and labour intensive exercise.

It will be appreciated that the method and system described herein can be used in a number of manners. In particular, in one form, the advertiser requests supply of a product and the plurality of responders are each interested suppliers of the product. In an additional or alternate form, the advertiser advertises supply of a product and the plurality of responders are each interested purchasers of the product. The product can be a tangible product, such as a good, or an intangible product, such as a service.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

The present invention is applicable to all professional and non-professional fields. Although the detailed description is with respect to jobs and services, it can be equally applied to products, processes, services, jobs or the like, where the entities involved could vary from buyers, sellers, hirers, providers, suppliers, job advertisers, manufacturers, retailers, customers and the like.

Furthermore, it is presently evident that job advertisers typically include corporations, recruiters, or the like. It is often difficult to be able to advertise a service or skill that can be provided by a job seeker. Additionally, micro business (businesses employing 0 to 4 people) that constitutes 80% of all businesses in the world, find it difficult to recruit people in the present environment which is dominated by corporations, recruiters and the like. These micro businesses by their very nature, have smaller budgets, recruit people on casual or short term basis and typically operate in the suburbs. Smaller budgets also mean smaller revenues. It will be appreciated that the disclosed aspects of the present invention seek to address these problems.

It will be appreciated that the above-described embodiments and examples can be used separately or in combination.

1. A server processing system for providing an advertising service, wherein the server processing system is configured to:
publish an advertisement, the advertisement being generated based upon advertising information received, by the server processing system, from an advertiser;
forward, to the advertiser, a plurality of responses from a respective plurality of responders;
receive from the advertiser, shortlist data indicative of a portion of the responders which the advertiser shortlisted; and
award the responders who have been shortlisted, wherein awarding each responder shortlisted includes the server processing system recording, in a data store associated with the server processing system, a credit in an account associated with each respective responder; and
selectively enable communication between the advertiser and one or more responders shortlisted via the server processing system, wherein the server processing system is configured to:
determine, using records stored in the data store, if one or more of the responders has credit stored in a respective account to allow the advertiser to freely communicate with the respective responder; and
in the event of a positive determination, debit the account, associated with the respective one or more responders when shortlisted, to enable communication between the advertiser and the respective one or more responders via the server processing system.

2. The server processing system according to claim 1, wherein the server processing system is configured to:
determine, using records stored in the data store, if one or more responders have purchased a subscription to use the advertising service; and
enable the advertiser to freely communicate, via the server processing system, with each responder shortlisted who purchased a subscription.

3. The server processing system according to claim 1, wherein the server processing system is configured to:
identify, using records stored in the data store, one or more of the responders who are restricted responders, each restricted responder failing to have purchased a subscription to use the advertising service and failing to have credit in an account for enabling free communication between the advertiser and the respective responder;
determine, using records stored in the data store, if the advertiser has met or exceeded a maximum threshold of restricted responders which the advertiser is able to freely communicate therewith during a predefined period;
in the event of a negative determination, update the records stored in the data store indicative of the number of restricted responders which the advertiser has communicated therewith in the predefined period prior to enabling the advertiser to freely communicate with the restricted responder; and
in the event of a positive determination, debit an account associated with the advertiser to enable the advertiser to freely communicate with at least one of the restricted responders.

4. The server processing system according to claim 3, wherein the server processing system is configured to reset the number of restricted responders the advertiser is able to freely communicate therewith after the predefined period has expired.

5. The server processing system according to claim 1, wherein the server processing system is configured to:
determine, using records stored in the data store, if the advertiser has purchased a subscription for using the respective advertisement; and
in the event of a positive determination, enable the advertiser to communicate freely with any of the responders which the advertiser shortlists.

6. The server processing system according to claim 1, wherein:
the advertiser requests supply of a product and the plurality of responders are each interested suppliers of the product; or
the advertiser advertises supply of a product and the plurality of responders are each interested purchasers of the product.

7. The server processing system according to claim 6, wherein the product includes at least one of:
a good; and
a service.

8. A computer readable medium including executable instructions for configuring a server processing system for providing an advertising service, wherein the server processing system is configured by the executable instructions of the non-transient computer readable medium to:
publish an advertisement, the advertisement being generated based upon advertising information received, by the server processing system, from an advertiser;
forward, to the advertiser, a plurality of responses from a respective plurality of responders;
receive from the advertiser, shortlist data indicative of a portion of the responders which the advertiser shortlisted; and
award the responders who have been shortlisted, wherein awarding each responder shortlisted includes the server processing system recording, in a data store associated with the server processing system, a credit in an account associated with each respective responder; and
selectively enable communication between the advertiser and one or more responders shortlisted via the server processing system, wherein the server processing system is configured to:
determine, using records stores in the data store, if one or more of the responders has credit stored in a respective account to allow the advertiser to freely communicate with the respective responder; and
in the event of a positive determination, debit the account, associated with the respective one or more responders when shortlisted, to enable communication between the advertiser and the respective responder via the server processing system.

9. The computer readable medium according to claim 8, wherein the executable instructions configure the server processing system to:
determine, using records stored in the data store, if one or more responders have purchased a subscription to use the advertising service; and
enable the advertiser to freely communicate, via the server processing system, with each responder shortlisted who purchased a subscription.

10. The computer readable medium according to claim 8, wherein the executable instructions configure the server processing system to:
identify, using records stored in the data store, one or more of the responders who are restricted responders, each restricted responder failing to have purchased a subscription to use the advertising service and failing to have credit in an account for enabling free communication between the advertiser and the respective responder;
determine, using records stored in the data store, if the advertiser has met or exceeded a maximum threshold of restricted responders which the advertiser is able to freely communicate therewith during a predefined period;
in the event of a negative determination, update the records stored in the data store indicative of the number of restricted responders which the advertiser has communicated therewith in the predefined period prior to enabling the advertiser to freely communicate with the restricted responder; and
in the event of a positive determination, debit an account associated with the advertiser to enable the advertiser to freely communicate with at least one of the restricted responders.

11. The computer readable medium according to claim 10, wherein the executable instructions configure the server processing system to reset the number of restricted responders the advertiser is able to freely communicate therewith after the predefined period has expired.

12. The computer readable medium according to claim 8, wherein the server processing system is configured to:
determine, using records stored in the data store, if the advertiser has purchased a subscription for using the respective advertisement; and
in the event of a positive determination, enable the advertiser to communicate freely with any of the responders which the advertiser shortlists.

13. The computer readable medium according to claim 8, wherein:
the advertiser requests supply of a product and the plurality of responders are each interested suppliers of the product; or
the advertiser advertises supply of a product and the plurality of responders are each interested purchasers of the product.

14. The computer readable medium according to claim 13, wherein the product includes at least one of:
a good; and
a service.

15. A server processing system configured to:
receive a plurality of advertisements from a plurality of advertising parties;
receive, from a searching party, search criteria;
generate search results by searching the plurality of advertisements according to the search criteria, wherein the search results include one or more advertisements by one or more advertising parties;
forward, to the searching party, the search results;
receive from the searching party, shortlist data indicative of a portion of the advertisers which the searching party shortlisted; and
award the portion of the advertisers who have been shortlisted.

16. The server processing system according to claim 15, wherein the server processing system is configured to selectively enable communication between the searching party and one or more advertising parties shortlisted via the server processing system.

17. The server processing system according to claim 15, wherein the server processing system is further configured to:
determine, using records stored in the data store, if one or more of the advertising parties has credit stored in a respective account to allow the searching party to freely communicate with the respective one or more advertising parties; and
in the event of a positive determination, debit the account, associated with the respective one or more advertising parties when shortlisted, to enable communication between the searching party and the respective one or more advertising parties via the server processing system.

18. The server processing system according to claim 15, wherein the server processing system is configured to:
determine, using records stored in the data store, if one or more advertising parties have purchased a subscription to use the advertising service; and
enable the searching party to freely communicate, via the server processing system, with each advertising party shortlisted who purchased a subscription.

19. The server processing system according to claim 15, wherein the server processing system is configured to:
identify, using records stored in the data store, one or more of the advertising parties who are restricted advertising parties, each restricted advertising party failing to have purchased a subscription to use the advertising service and failing to have credit in an account for enabling free communication between the searching party and the respective advertising party;
determine, using records stored in the data store, if the searching party has met or exceeded a maximum threshold of restricted advertising parties which the searching party is able to freely communicate therewith during a predefined period;
in the event of a negative determination, update the records stored in the data store indicative of the number of restricted advertising parties which the searching party has communicated therewith in the predefined period prior to enabling the searching party to freely communicate with the restricted advertising party; and
in the event of a positive determination, debit an account associated with the searching party to enable the searching party to freely communicate with at least one of the restricted advertising parties.

20. The server processing system according to claim 15, wherein: the searching party searches for supply of a product or service by an advertising party; or the searching party searches for advertising parties to supply a product or service thereto.
